(19) United States
(12) Patent Application Publication
(10) Pub. No.: US 2012/0256531 A1
(43) Pub. Date: Oct. 11, 2012

(54) SPARK PLUG HAVING A HOLE FOR ADJUSTMENT

(76) Inventors: Jochen FUCHS, Wattens (AT); Markus Kraus, Wiesing (AT)

(21) Appl. No.: 13/530,540

(22) Filed: Jun. 22, 2012

Related U.S. Application Data
(63) Continuation of application No. PCT/AT2010/000465, filed on Dec. 3, 2010.

(30) Foreign Application Priority Data
Dec. 23, 2009 (AT) A 2026/2009

(51) Int. Cl. H01T 13/20; H01T 21/06

(52) U.S. Cl. 313/141; 445/3

(57) ABSTRACT

The invention relates to a spark plug, comprising a center electrode and a ground electrode, wherein the center electrode is arranged relative to the ground electrode in such a way that the spark gap extends between the ground electrode and the center electrode, wherein the spark gap is surrounded by a wall, wherein the wall has a recess or opening, which is designed in such a way that a feeler gauge can be inserted between the center electrode and the ground electrode.

The invention concerns a spark plug comprising a center electrode and a ground electrode, wherein the center electrode is so arranged relative to the ground electrode that the spark gap extends between the ground electrode and the center electrode, wherein the spark gap is surrounded by a wall. The invention further concerns a method of adjusting the spacing of the center electrode relative to the ground electrode of such a spark plug.

Spark plugs pass ignition current into the combustion chamber of an internal combustion engine and there ignite the fuel-air mixture by an ignition spark which flashes over between the electrodes (in the so-called spark gap). High temperatures occur in gas engines involving high power levels and large combustion chambers. In gas engines, an increasing trend is to provide a pre-chamber. The pre-chamber is markedly smaller in comparison with the actual combustion chamber and is separated from the combustion chamber by a wall, wherein relatively small transfer openings are provided to permit an exchange of fluid between the combustion chamber and the pre-chamber. Actual ignition with the spark plug takes place in the pre-chamber, in which case a comparatively rich fuel-air mixture is ignited there with the spark plug, the ignition flares which are produced in that case passing by way of the transfer openings into the actual combustion chamber and there igniting a comparatively weak fuel-air mixture.

To protect the ground electrode and the center electrode from the high temperatures a wall can be provided, which is a good heat conductor. In addition the electrodes can be extended closer to the insulating body of the spark plug to ensure a faster flow of heat into the spark plug casing. It will be noted however that this means that the electrodes are made more difficult to access from the exterior. In the state of the art it was therefore necessary, after a certain operating time, to increase the ignition voltage in order to compensate for the spacing between the center electrode and the ground electrode, which becomes larger due to electroerosion. An alternative variant provides that the spark gap is not arranged parallel to the longitudinal axis of the spark plug but perpendicularly thereto in order to achieve access to the spark gap at least from the end of the spark plug. The disadvantage of that procedure however is that, in the case of such spark plugs, a plurality of ground electrodes are required as otherwise the ignition spark extends asymmetrically and the spark gap which is parallel to the longitudinal axis of the spark plug is undesirable.

Therefore the object of the present invention, in a spark plug of the kind set forth in the opening part of this specification, is to improve the possibility of adjusting the spacing between the center electrode and the ground electrode.

That object is attained in that the wall has a recess or opening which is so designed that a feeler gauge can be inserted between the center electrode and the ground electrode.

The basic idea is therefore that the spark gap is left to be for example along the or parallel to the longitudinal axis of the spark plug and is to be made accessible from the side of the spark plug. In that respect the fact that the wall surrounding the ground electrode and the center electrode is weakened by the recess or opening is intentionally tolerated. Preferably the spark gap then extends along the or parallel to the longitudinal axis of the spark plug. The spark gap is that gap between the ground electrode and the center electrode, in which the spark jumps across. In that respect the feature that the wall surrounds the spark gap is to be interpreted in such a way that the spark gap is either completely surrounded by the wall in the radial direction, or it is surrounded by the body or housing of the spark plug where there is no wall.

The weakening of the wall is less significant if there is provided a fastening portion for fastening the spark plug in a combustion chamber housing of an internal combustion engine, wherein the recess or opening is completely covered by the combustion chamber housing in the condition of installation of the spark plug in the combustion chamber housing.

In the simplest case it can be provided that the fastening portion includes a male thread and the wall at least region-wise carries the male thread.

In a preferred variant it can be provided that the recess or opening is arranged in the region of the male thread.

An advantageous configuration of the invention provides that the ground electrode is connected to the wall by way of a leg. It is advantageously provided in that respect that the leg extends substantially perpendicularly to the longitudinal axis of the spark plug.

To permit accessibility to the spark gap particularly well and to make the lever relationships for subsequent adjustment optimum, it can be provided that the recess or opening is arranged in the wall at the opposite side of the fastening location of the leg to the wall.

The wall, leg and ground electrode can be permanently connected together, for example welded or made in one piece, or can otherwise be permanently connected together.

It can further be provided that in the region of the recess or opening the wall is of a cross-section which is substantially in the shape of a circular ring, wherein the recess or opening extends over a region of between 3 and 10%, preferably between 5 and 7%, along the outside periphery of the circle. In that way the wall is only minimally weakened. Possibly not just one but a plurality of openings can be provided. The shape of the at least one opening is in the simplest case matched to the feeler gauge. It can be for example of a circular, square, rectangular or polygonal configuration.

It can also be provided that the longitudinal extent of the recess or opening along the spark gap is between one and two times the spacing between the center electrode and the ground electrode.

The above-mentioned advantageous configuration with pre-chamber ignition is frequently achieved by the pre-chamber being introduced into the combustion chamber as a separate component. In the present case however it would be possible for the pre-chamber to be formed directly at the spark plug. It can therefore be provided that at the end there is provided a preferably dome-shaped cover which in the installed condition separates the ground electrode and the center electrode from the combustion chamber of the internal combustion engine, wherein there are provided transfer openings in the cover. Such a configuration would also have the advantage that no structural modification measures would be required on the internal combustion engine to change over from a “normal” combustion chamber ignition to pre-chamber ignition.

In a further aspect the invention concerns a method of adjusting the spacing between a center electrode and a ground electrode in a spark plug of the specified kind. The method is distinguished in that a feeler gauge of a thickness which corresponds to the desired spacing of ground electrode to center electrode is inserted by way of the recess or opening and the ground electrode is pressed relative to the center electrode until the spacing of the center electrode relative to the ground electrode corresponds to the thickness of the feeler gauge.

Further advantages and details of the invention are described by means of the accompanying Figures and the specific description.

In the Figures:

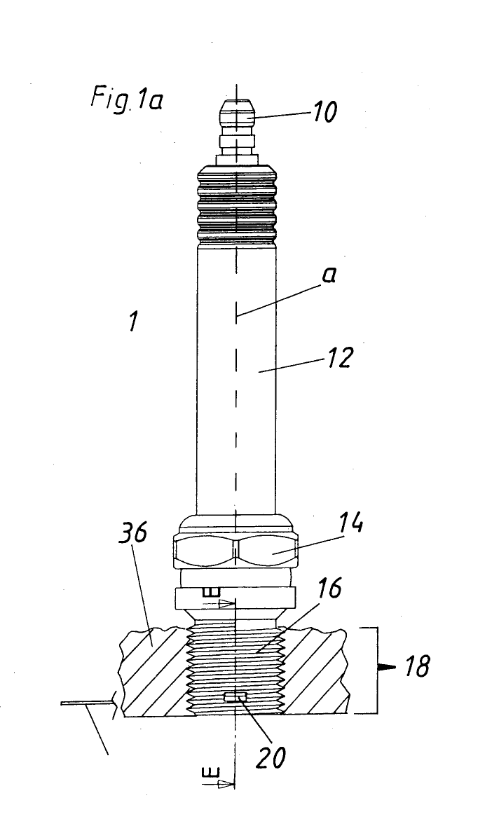

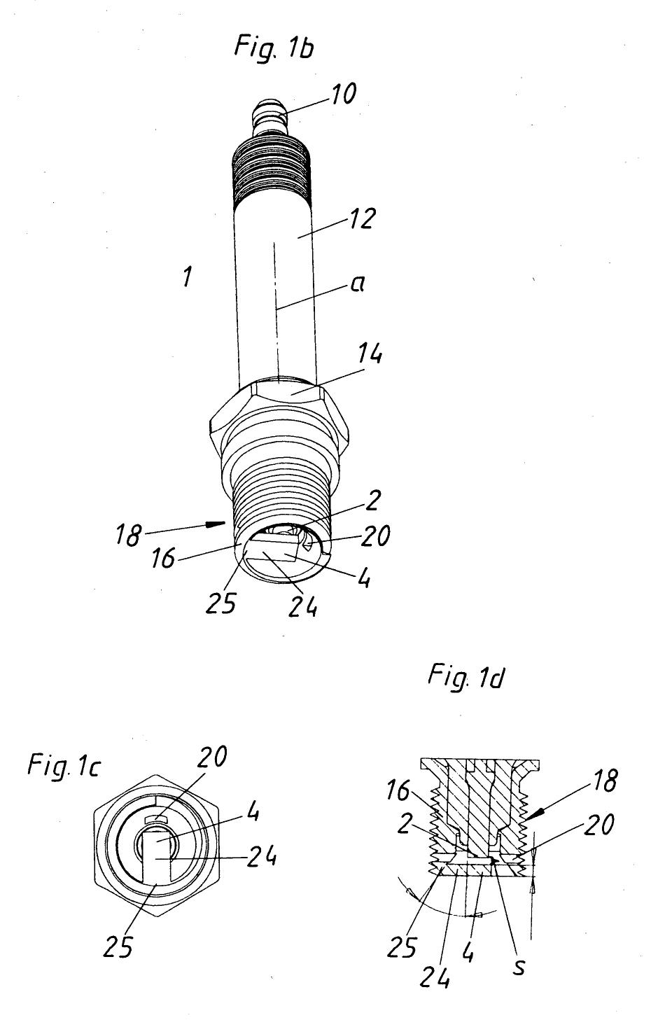

FIGS. 1a through 1d show four views of a first variant of a spark plug,

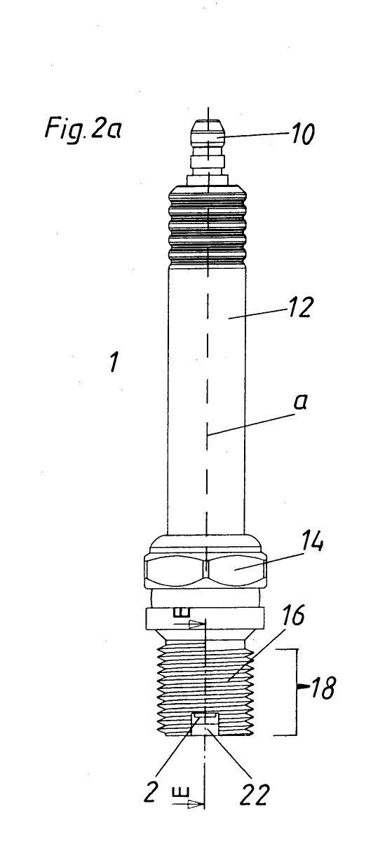

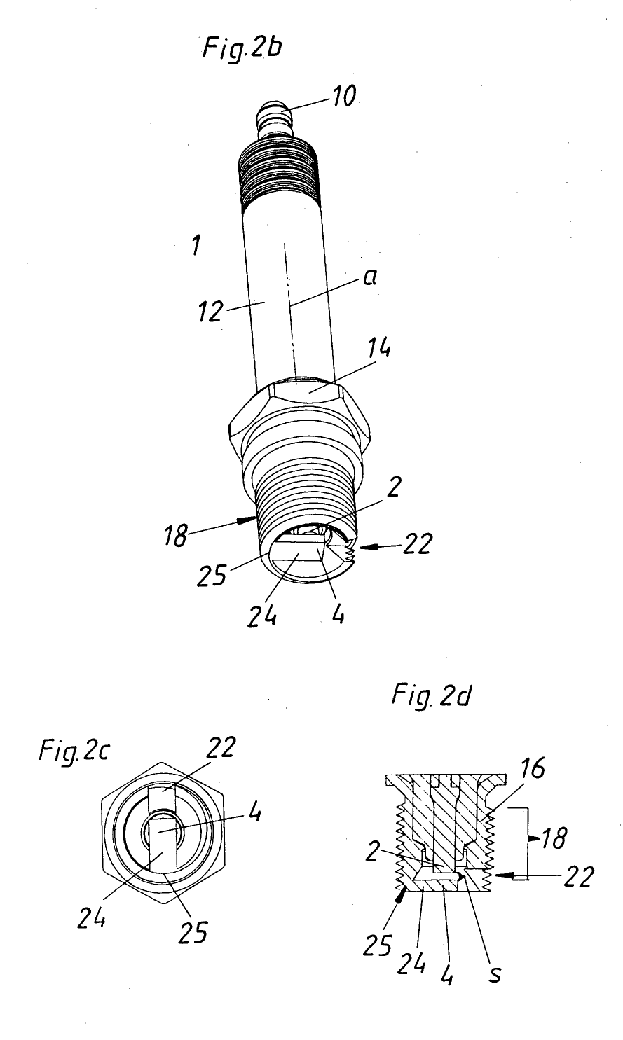

FIGS. 2a through 2d show four views of a second variant of a spark plug,

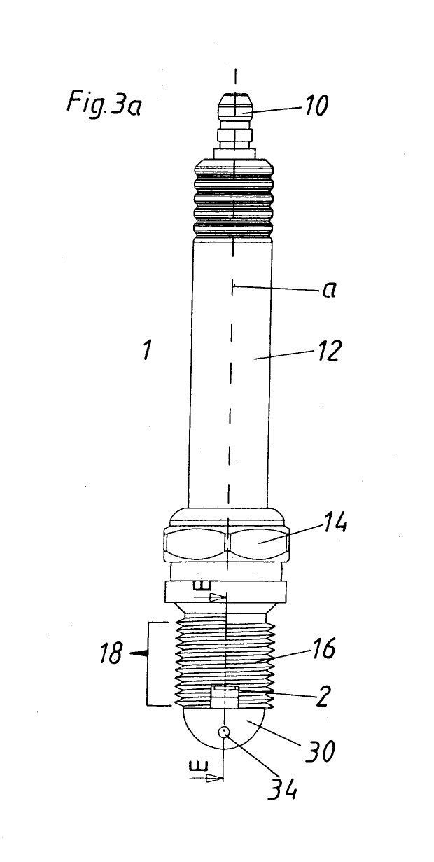

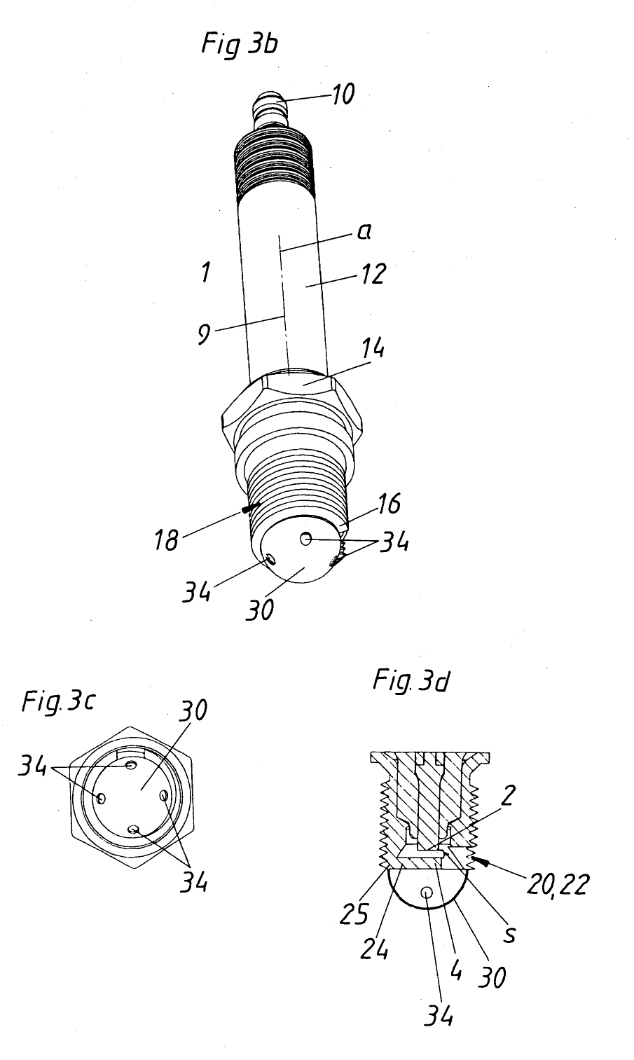

FIGS. 3a through 3d show four views of a third variant of a spark plug according to the invention.

FIG. 1a shows a side view of a spark plug 1 according to a first variant of the invention. FIG. 1b shows an inclined view of the spark plug 1, FIG. 1c shows a view onto the end of the spark plug 1 and FIG. 1d shows a cross-section along plane E-E of the view in FIG. 1a. The spark plug 1 is described with reference to the four views. The spark plug 1 includes an insulating body 12 generally made from ceramic. Disposed at the top side is a connecting portion 10 which is electrically conducting and which is connected to an ignition coil or the like. The connecting portion 10 delivers the voltage to the center electrode 2 which extends in the interior of the ceramic body to the end where the center electrode 2 projects from the insulating body 12. The spark plug 1 further has a screw-in portion 14, generally in the form of a hexagon for screwing the spark plug 1 into the combustion chamber housing (diagrammatically shown at 36) of an internal combustion engine (not shown). There is also a thread 18 with which the spark plug 1 can be permanently connected to the combustion chamber housing 36. The thread 18 is arranged on the wall 16 which surrounds the ground electrode 4 and the center electrode 2 in such a way that the spark gap s is surrounded by that wall 16. A leg 24 extends from the wall 16 to the center of the spark plug 1, where the actual ground electrode 4 is formed as a counterpart electrode to the center electrode 2. It can be seen that the spark gap s between the ground electrode 4 and the center electrode 2 is formed in such a way that it extends along the longitudinal axis a of the spark plug 1.

Now, according to the invention there is provided an opening 20 through which a feeler gauge 32 can be inserted. Arranged on both sides of the wall 16 is a respective opening 20 which also is so arranged that the feeler gauge can be inserted from each side and can possibly be completely pushed through. By pressure being applied to the ground electrode 4 the spacing relative to the center electrode can be reduced by the leg 24 yielding somewhat until the thickness of the feeler gauge 32 is reached and the desired electrode spacing s is set. As can be seen from the described embodiment the wall 16 is of a somewhat circular configuration in the region of the opening 20. The opening 20 is arranged on the side opposite to the fastening region 25 of the leg 24. With respect to the periphery of the wall 16 the width b of the opening 20 constitutes about 6%. In regard to the thickness, that is to say the longitudinal extent k along the longitudinal axis a of the spark plug 1, the opening is slightly thicker than the electrode spacing s so that the feeler gauge 32 can be well inserted.

FIGS. 2a through 2d show a variant of the invention which substantially corresponds to that shown in FIGS. 1a through 1d. In that respect therefore attention can be directed to the specific description relating to FIGS. 1a through 1d. FIG. 2a shows a side view, FIG. 2b shows an inclined view, FIG. 2c shows a view onto the end and FIG. 2d shows a sectional view along plane E-E in FIG. 2a. Unlike the embodiment of FIGS. 1a through 1d a recess 22 is now provided in place of an opening 20. The opening 20 also permits access for the feeler gauge 32. The width b of the recess 22 corresponds to the width b of the opening 20 in FIGS. 1a through 1d, while the longitudinal extent k is about three times the thickness of the electrode spacing y.

FIGS. 3a through 3d show a further variant of a spark plug 1 according to the invention, based on FIGS. 1a through 1d and 2a through 2d. Reference can also be made to the preceding specific description. In that respect FIG. 3a shows a side view, FIG. 3b an inclined view, FIG. 3c a view onto the end and FIG. 3d a sectional view along plane E-E in FIG. 3a. Unlike the embodiment of FIGS. 2a through 2d there is now additionally provided a cover 30 which delimits the spark plug 1 at the end, that is to say at the electrode end. The actual wall 16 in this case has a recess 22 or an opening 20 which extends to the end of the thread 18. That is followed by a hemispherical dome forming the cover 30. Arranged on the cover 30 are flow transfer bores 34 which form the fluid exchange between the enclosed space in the spark plug 1 and the actual combustion chamber.

As can be seen from the Figures the opening 20 or recess 22 is covered by the wall 16 of the combustion chamber housing in the installed condition as the spark plug is installed over the entire threaded portion 18. The combustion chamber housing is diagrammatically indicated by 36 in that respect in FIG. 1.

As can also be seen from all the Figures the spark plugs have a wall 16 which conically converge in the interior towards the center of the spark plug 1. The space between the ground electrode 24 towards the insulating body 12 is therefore of a frustoconical configuration. In that way heat can be even better dissipated from the two electrodes 2, 4.

1. A spark plug comprising a center electrode and a ground electrode, wherein the center electrode is arranged relative to the ground electrode so that the spark gap extends between the ground electrode and the center electrode, wherein the spark gap is surrounded by a wall which to form a fastening portion for fastening the spark plug in a combustion chamber housing of an internal combustion engine at least region-wise carries a male thread, wherein the wall has an opening which is arranged in the region of the male thread and is so designed that a feeler gauge can be inserted between the center electrode and the ground electrode, wherein the opening is surrounded on all sides by the male thread.

2. A spark plug as set forth in claim 1, wherein the ground electrode is connected to the wall by way of a leg.

3. A spark plug as set forth in claim 2, wherein the leg extends substantially perpendicularly to the longitudinal axis of the spark plug.

4. A spark plug as set forth in claim 3, wherein the opening is arranged in the wall at the side in opposite relationship to the fastening location of the leg to the wall.

5. A spark plug as set forth in claim 2, wherein the wall, leg and ground electrode are in one piece.

6. A spark plug as set forth in claim 1, wherein in the region of the opening the wall is of a cross-section which is substantially in the shape of a circular ring, and the opening extends over a region of between 3 and 10% along the outside periphery of the circle.

7. A spark plug as set forth in claim 1, wherein the longitudinal extent of the opening along the spark gap is between one and three times the spacing between the center electrode and the ground electrode.

8. A spark plug as set forth in claim 1, wherein at the end there is provided a dome-shaped cover which in the installed condition separates the ground electrode and the center electrode from the combustion chamber of the internal combustion engine, and transfer openings are disposed in the cover.

9. A method of adjusting the spacing between a center electrode and a ground electrode of a spark plug as set forth in claim 1, wherein a feeler gauge having a thickness which corresponds to a desired spacing is inserted via the opening, and the ground electrode is pressed relative to the center electrode until the spacing of the center electrode relative to the ground electrode corresponds to the thickness of the feeler gauge.
